(19) United States
(12) Patent Application Publication
(10) Pub. No.: US 2003/0170595 A1
(43) Pub. Date: Sep. 11, 2003

(54) Educational chart for teaching reading and other subjects

(76) Inventor: Elaine Thompson, Neshanic Station, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/095,338

(22) Filed: Mar. 11, 2002

(51) Int. Cl. G09B 1/00

(52) U.S. Cl. 434/159

(57) ABSTRACT

An educational chart includes a substrate having a plurality of different regions formed thereon. One region includes a plurality of letter regions for use in teaching a user reading concepts. Each letter region includes a letter of an alphabet or a combination of letters of the alphabet and a series of words corresponding to the letter or the combination of the letters. Each letter region may further include a picture of an object corresponding to the letter or the combination of letters and, optionally, a word identifying the object. At least one other region formed on the substrate includes information for teaching the user a first subject different from the reading concepts.

### BACKGROUND OF THE INVENTION

The present invention relates generally to classroom education, and more particularly to a device for teaching children how to read. Still more particularly, the present invention is directed to a device which combines educational assistance in reading and other subjects on a single chart.

Classrooms of early school-age children are typically filled with a variety of devices used by teachers to teach children a wide range of subjects. One currently popular device which is used to help children learn to read is an alphabet chart. An alphabet chart depicts all of the letters of the alphabet. Associated with each letter is a picture of an object whose name begins with that letter, along with the name of the object itself. For example, the chart may depict the letter “A” along with the word “Apple” and a picture of an apple. The association of the picture and word with the letter helps a child learn the sound each letter makes.

In addition to alphabet charts, a typical classroom may include other educational charts and devices, such as a calendar for teaching days, months and years; a number line for teaching counting and other numbering concepts; a facsimile of a clock for teaching how to tell time; a lettering chart for teaching how to write in cursive; etc.

One problem with the foregoing teaching aids is that they are embodied in multiple different devices which are mounted on walls around the classroom. Therefore, in order for a child to make effective use of these teaching aids, he or she must first look around the classroom to locate the particular teaching aid desired. While some of these teaching aids may be located at or near the front of the classroom, other teaching aids may be at or near the back of the classroom, requiring the child to turn around to use it. This not only makes the teaching aid difficult to use, but is distracting to the children in the classroom, particularly where the children are working on different subjects and therefore looking in many different directions.

Another problem with these teaching aids is that, once located, they may be too far away for a child to use. For example, children in the back of the classroom may have difficulty in seeing a teaching aid in the front of the classroom, and children at the front of the classroom may have difficulty seeing a teaching aid at the back of the classroom.

Still another problem with current teaching aids is that a single teaching aid in a particular subject may not be appropriate for all of the children in the classroom. That is, some children may be at a more advanced level of learning than other children in the classroom. In such event, a teaching aid appropriate for slower learners in the classroom may be of no use to the more advanced learners and vice versa.

In view of the foregoing, there exists a need for a teaching aid for classroom use which will overcome many of the deficiencies in the currently available teaching aids. More particularly, there exists a need for a teaching aid which can be easily seen and used by each child in the classroom without distracting the other children in the classroom. There further exists a need for a teaching aid which can accommodate children in the classroom who are at different levels of learning. Preferably, such teaching aid will be inexpensive to produce so as to be available in many different versions, yet readily affordable to all schools, including those in poorer school districts.

### SUMMARY OF THE INVENTION

The present invention addresses these needs.

An educational chart in accordance with one embodiment of the present invention includes a substrate; a plurality of letter regions formed on the substrate for use in teaching a user reading concepts, each of the letter regions including a letter of an alphabet or a combination of letters of the alphabet, and a series of words corresponding to the letter or the combination of letters. The educational chart further includes at least one teaching region including information for use in teaching the user a first subject. Preferably, the first subject is different from the reading concepts. The alphabet may be an Arabic alphabet or a foreign language alphabet.

In preferred embodiments, each of the letter regions may further include a picture of an object corresponding to the letter or the combination of letters. In such embodiments, each of the letter regions may further include a word identifying the object. Furthermore, such embodiments may include a background color surrounding each of the pictures of the objects, wherein the background color for each of the pictures is different from a background color for an adjacent one of the pictures.

Educational charts in accordance with the present invention may further include another teaching region including information for use in teaching the user a second subject different from the reading concepts. The second subject may also be different from the first subject.

In embodiments hereof, the first subject may be selected from the group consisting of number concepts, color concepts, directional concepts, geometric concepts, writing concepts, time concepts, calendar concepts, astronomy concepts, language concepts, mathematics concepts, measurement concepts, chemistry concepts, historical concepts, geographical concepts, reading concepts and combinations thereof. Alternatively, the first subject may be selected from the group consisting of contractions, abbreviations and combinations thereof.

The educational chart of the present invention may further include a series of numbers arranged in a linear array. Alternatively, or in addition thereto, the educational chart may include a ruler.

In other preferred embodiments hereof, the educational chart may include a substantially blank area positioned adjacent the plurality of letter regions. The substantially blank area may have an erasable surface.

Preferably, the substrate of the educational chart has a pair of opposed longitudinal edges, the plurality of letter regions being formed along one of the longitudinal edges.

In accordance with this embodiment, the educational chart may include a series of numbers arranged in a linear array along another one of the longitudinal edges. Alternatively, the educational chart may include a ruler formed along another one of the longitudinal edges.

In highly preferred embodiments hereof, each of the words in the series of words begins with the letter or the combination of letters.

In other highly preferred embodiments hereof in which each of the letter regions includes the combination of letters, each of the words in the series of words includes the combination of letters. Preferably, the combination of letters represents a sound, and each of the words in the series rhymes with the sound.

An educational chart in accordance with another embodiment of the present invention includes a substrate; an alphabet region formed on the substrate for use in teaching a user reading concepts, the alphabet region including letters of an alphabet. For each of the letters of the alphabet, the alphabet region includes a series of words corresponding to the letter. The educational chart further includes at least one teaching region including information for use in teaching the user a first subject. Preferably, the first subject is different from the reading concepts.

In preferred variants of this embodiment, for each of the letters of the alphabet, the alphabet region further includes a picture of an object corresponding to the letter of the alphabet. Preferably, the alphabet region further includes a word identifying each of the objects.

In highly preferred embodiments, the letters of the alphabet are vowels or combinations of vowels.

### BRIEF DESCRIPTION OF THE DRAWINGS

A more complete appreciation of the subject matter of the present invention and the various advantages thereof can be realized by reference to the following detailed description, in which reference is made to the accompanying drawings in which:

FIG. 1 is a plan view of a first embodiment of the educational device of the present invention;

FIG. 2 is a plan view of a second embodiment of the educational device of the present invention;

FIG. 3 is a plan view of a third embodiment of the educational device of the present invention; and

FIG. 4 is a plan view of a template for forming educational devices in accordance with the first, second and third embodiments of the present invention.

### DETAILED DESCRIPTION

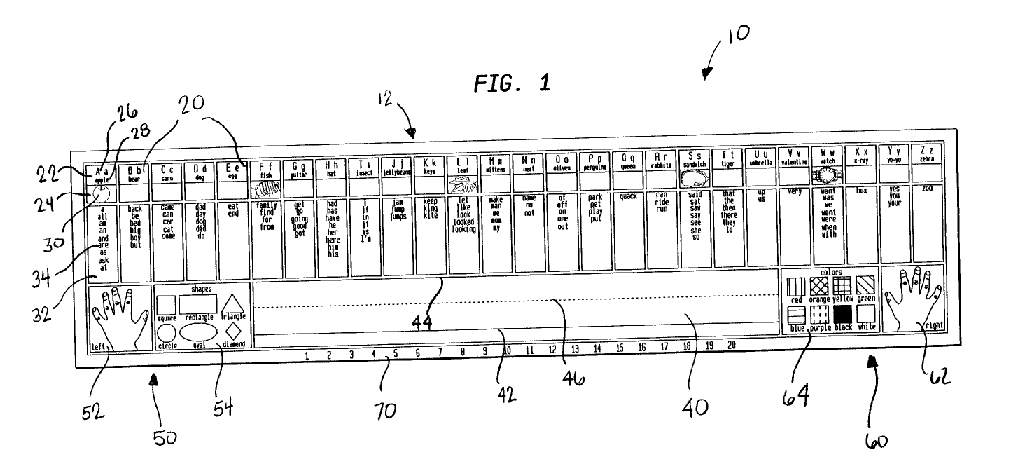

A first embodiment of the educational device of the present invention is depicted in FIG. 1. The educational device is in the form of an elongated chart 10 formed from paper, light cardboard stock, plastic or another relatively inexpensive material. Although the exact size of chart 10 is not critical, the chart is preferably sized so as to fit on the top of a student's desk or work area. An example of one convenient size is a chart 10 having a length of about 18 inches and a height of about 4.5 inches. However, chart 10 may be proportionally larger or smaller, or may be sized in different proportions as needed to accommodate the different teaching areas of the chart as discussed below. Being sized to fit on a child's desk enables each child to have his or her own chart right in front of him or her, thereby eliminating the difficulties and distractions in locating and using multiple charts situated throughout the classroom.

Along the top portion of chart 10 is an alphabet region 12 including a series of 26 boxes 20, one for each letter of the Arabic alphabet. Each box is divided into two portions, a top portion 22 and a bottom portion 24. The top portion 22 of each box includes a letter of the alphabet 26 in upper case and/or lower case form. Optionally, the top portion 22 of each box may also include a word 28 beginning with the letter in that top portion. Where the top portion 22 includes a word 28, the bottom portion 24 of each box may include a picture 30 of an object denoted by the word 28. Thus, referring to FIG. 1, the first box 20 includes the letters “A” and “a” and the word “apple” in top portion 22, and a picture of an apple in bottom portion 24. The top portions 22 of boxes 20 may be formed all in the same color or in multiple different colors in order to capture and hold the attention of children and help distinguish one box 20 from adjacent boxes 20.

Positioned below each box 20 in alphabet region 12 is an elongated box 32. Each box 32 includes a list of words 34, each of which is related in some way to the letter of the alphabet under which it is positioned. In a preferred embodiment, each of words 34 begins with the letter of the alphabet under which it is positioned. Words 34 preferably are words which are used commonly in every day language, and may be particularly selected to reflect the different pronunciations of their beginning letters. Collectively, the various portions of alphabet region 12 are intended to teach children reading concepts.

Words 28 and 34 may be selected depending upon the grade level at which chart 10 is to be used. Thus, for example, in charts 10 used for kindergarten or first grade, these words may be simple one-syllable words, and in charts used for third and fourth grades, these words may be more difficult multi-syllable words. For charts used for later grade levels, words 28 and 34 may be more advanced.

In a central portion below boxes 32, chart 10 may include a substantially blank area 40 which can be used to write the child's name, to practice lettering, to practice spelling, or for similar uses. In that regard, area 40 may include a series of lines conventionally used to practice lettering, including a lower solid line 42, an upper solid line 44 and a dashed line 46 interposed between solid lines 42 and 44. To facilitate the use of area 40 to practice lettering, chart 10, or at least area 40, may be provided with a readily erasable surface, such as one from which a conventional dry-erase marker may be easily erased.

On either side of substantially blank area 40, chart 10 includes a first region 50 and a second region 60 which may be used to teach various subjects. Although information for teaching reading concepts may be provided in regions 50 and/or 60, the present invention is not so limited. Rather, the present invention is particularly advantageous when regions 50 and 60 include information for teaching subjects other than reading concepts. For example, as shown in FIG. 1, region 50 may include an area 52 in which the left hand of a person is depicted, and region 60 may include an area 62 in which the right hand of a person is depicted. These depictions may teach young children the differences between a left hand and a right hand and, ultimately, concepts of direction.

As shown in FIG. 1, region 50 may include another area 54 used to teach children another subject, such as different geometric shapes. In that regard, area 54 may include illustrations of a square, rectangle, triangle, circle, oval and diamond, as shown in the figure, or additional or different geometric shapes. Alternatively, area 54 may be used to teach children more advanced geometric shapes, such as hexagons, octagons, cylinders, cones, pyramids, trapezoids, etc., or other geometric concepts, such as parallelograms, triangles, angles, area, volume, measurements of a circle, sine and cosine functions, etc.

Similarly, region 60 may include another area 64 to teach another subject, such as colors. Thus, area 64 may include a plurality of color patches with the name of each color printed adjacent each color patch. Alternatively, area 64 may be used to teach other concepts regarding color, such as concepts of color mixing.

Along its bottom edge, chart 10 may include a linear array of numbers 70. As shown in FIG. 1, number array 70 lists the numbers from 1 to 20. However, as will be explained further below, depending upon the age of the child to which the charts of the present invention are directed, the number array may list numbers in sequence in ascending order. Alternatively, the number arrays may not list the numbers in sequence, but may list them by counting in twos, fives, tens, etc. Optionally, rather than a number array, chart 10 may include a ruler in English or metric units for use in measurement.

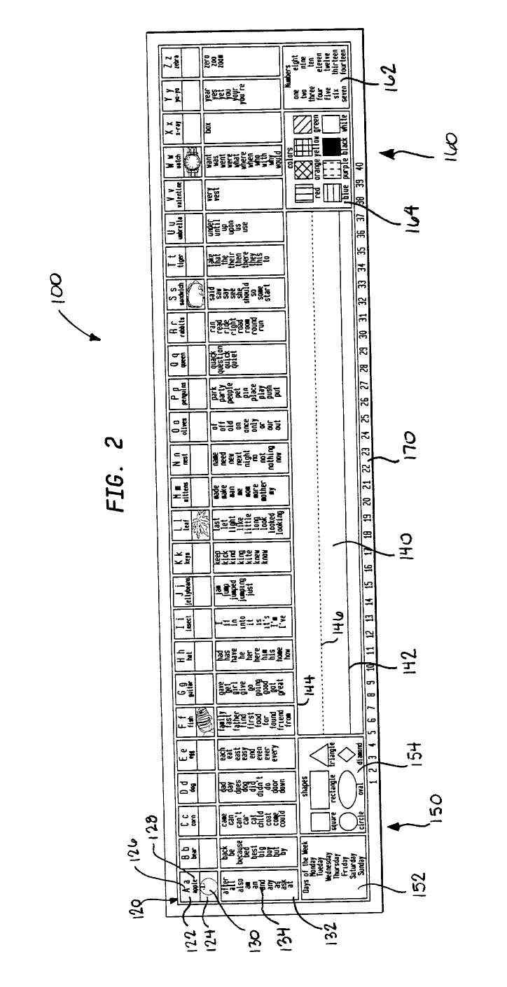

FIG. 2 depicts an educational chart 100 in accordance with a second embodiment of the present invention. Chart 100 is similar to chart 10 described above, and includes an alphabet region 112 intended to be used to teach children reading concepts. Alphabet region 112 includes a series of twenty-six boxes 120 each depicting a letter of the alphabet 126 and a word 128 beginning with that letter in a top portion 122, and a picture 130 of an object denoted by the word 128 in a bottom portion 124. Below each box 120 is an elongated box 132 which includes a list of words 134, each of which is related to the letter of the alphabet under which it is positioned, preferably beginning with that letter. Depending upon the age of the child intended to use chart 100, words 128 and 134 may be the same as words 28 and 34 described above, or may be either simpler or more complex.

Below boxes 132, a central portion of chart 100 may include a substantially blank area 140 having a lower solid line 142, an upper solid line 144 and an intermediate dashed line 136. Area 140 may be used to write the child's name or to practice lettering.

On either side of substantially blank area 140, chart 100 may include a first teaching region 150 and a second teaching region 160 for use in teaching subjects other than reading concepts. As shown in FIG. 2, teaching region 150 is divided into two teaching areas 152 and 154. Teaching area 154 depicts the same geometric shapes as are depicted in teaching area 54 of chart 10 discussed above. Thus, area 154 may be used to teach about these geometric shapes, or about various other geometric concepts as discussed above in connection with chart 10. However, rather than depicting a left hand as in teaching area 52 of chart 10, teaching area 152 lists the days of the week. Thus, teaching area 152 may be used to teach various concepts about the days of the week, including the order of the days, spelling, etc.

Similarly, teaching region 160 is divided into two teaching areas 162 and 164. Teaching area 164 depicts the same colors as are shown in teaching area 64 of chart 10, and may be used to teach the same color concepts. However, rather than depicting the right hand of a person as in teaching area 62 of chart 10 described above, teaching area 162 spells out the numbers from 1 to 14. Hence, teaching area 162 may be used to teach number concepts, including the spelling of these numbers.

As with chart 10, chart 100 includes a linear array of numbers 170 along its bottom edge. As shown in FIG. 2, number array 170 depicts the numbers 1 through 40 in sequence. It will thus be appreciated that the number array 170 of chart 100 may be used to teach more advanced number concepts than the number array 70 of chart 10.

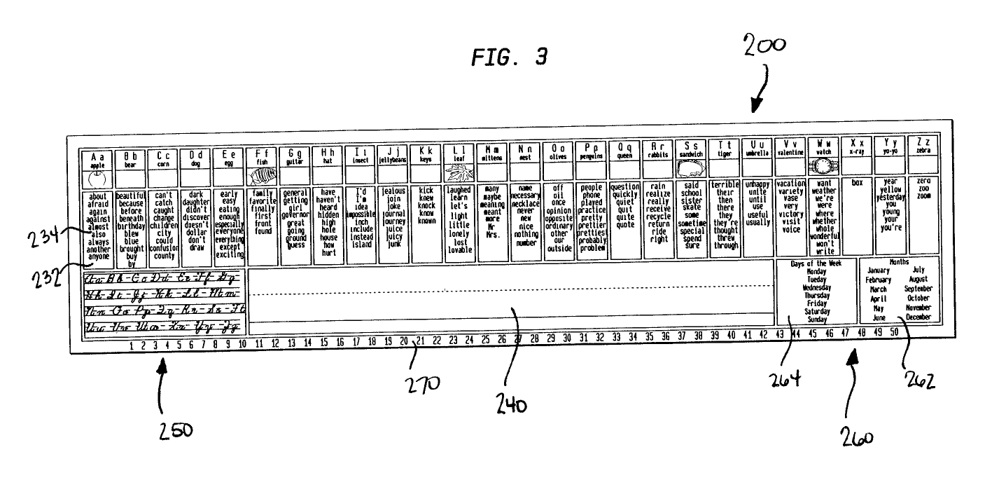

A chart 200 in accordance with a third embodiment of the present invention is depicted in FIG. 3. Chart 200 is similar to charts 10 and 100 described above. However, it will be appreciated that the words 234 in boxes 232 of alphabet region 212 are more advanced than the words depicted in charts 10 and 100. Hence, chart 200 may be used to teach more advanced reading and language concepts than charts 10 and 100.

As shown in FIG. 3, the teaching charts of the present invention need not include two separate teaching areas in each teaching region. That is, while chart 200 includes first and second teaching regions 250 and 260, one on each side of substantially blank area 240, teaching region 250 defines a single teaching area, rather than being divided into two separate teaching areas as in the embodiments described above. More particularly, as shown in FIG. 3, teaching region 250 defines a single area in which the letters of the alphabet are depicted in both uppercase and lowercase cursive lettering. Accordingly, region 250 may be used to teach children how to write in cursive lettering, which the children may practice in substantially blank area 240.

As with the embodiments described above, however, teaching region 260 is divided into two distinct teaching areas 262 and 264. Teaching area 262 lists the months of the year, while teaching area 264 lists the days of the week in a manner similar to teaching area 152 described above. Teaching areas 262 and 264 therefore may be used together to teach various calendar concepts.

Along its bottom edge, chart 200 includes a linear number array 270 which depicts the numbers sequentially from 1 to 50. Hence, it will be appreciated that chart 200 may be used to teach more advanced number concepts than either chart 10 or chart 100 described above.

While specific embodiments of the educational device of the present invention have been described above, it will be appreciated that numerous variants may be devised depending upon the subjects and concepts to be taught in addition to reading concepts. For example, in addition to teaching concepts about the right and left hands and directionality, colors, lettering, geometry, numbers and the calendar, embodiments of the present invention may have teaching areas which include a clock face to teach concepts about telling time; pictures of planets, stars and other bodies, or the names of planets and other such bodies, for teaching astronomy concepts; foreign words to teach language concepts; tables for teaching math concepts, including addition, subtraction, multiplication and division tables; time lines and other information for teaching concepts of time, including time zones; pictures and/or words for use in teaching concepts of measurement, including distance, weight and/or volume; a periodic table of the elements and/or the names and symbols of chemicals for teaching chemistry concepts; a listing of the U.S. Presidents or other historical figures or facts; a listing of states with or without their capitols, countries, continents, oceans or other geographic concepts; depictions of flags of states or countries; or any other information which is typically taught in school. Furthermore, the teaching areas may include a listing of words or terms for teaching additional reading concepts, such as common contractions (e.g., can't, isn't, etc.) or common abbreviations (e.g., Mr., Mrs., Rd., St., etc.)

In addition, while the present invention has been described above in connection with embodiments which depict the Arabic alphabet in alphabet regions 12, 112 and 212, the educational charts may be prepared in a foreign language, and thus may depict an alphabet other than the Arabic alphabet in these alphabet regions. Accordingly, these alphabet regions may have more or less than 26 boxes depending on the number of letters in the subject alphabet. Also, the various words in the alphabet region may be depicted in the relevant language, as may the days of the week, months, color names, geometric shapes, numbers, etc. in the teaching regions and teaching areas of the chart.

The educational device of the present invention may be modified in still other ways dependent upon the particular way in which the device is to be used. In one variant hereof, rather than depicting the letters of an alphabet in alphabet regions 12, 112 and 212, a chart in accordance with the present invention can depict frequently occurring letter chunks or blends, along with a word including that chunk or blend. The alphabet region may further include a picture of an object denoted by the word, as well as a list of words including that chunk or blend. For example, one box in the alphabet region can include the chunk “br”, the word “broom” and a picture of a broom, along with a list of words which include the “br” combination. As another example, the alphabet region may include the chunk “ch”, the word “chair”, and a picture of a chair, along with a list of words that include the “ch” combination.

As another variant, the alphabet region can include only vowels and/or frequently occurring vowel combinations (such as “ee”, “ea”, “oo”, “ou”, etc.), along with a picture of an object representing each vowel or vowel combination, and associated words. Alternatively, the alphabet region could include letters and letter combinations which have the same sound (such as “f”, “ph” and “gh”) along with representative pictures and words.

In yet another variant of the present invention, the alphabet region can include a series of word features, along with a family of words that rhyme with or that include that feature. For example, one box in the alphabet region may include the letters “an” and, optionally, a picture of an object which represents the letters “an” (such as a picture of a man), along with the word “man”. In an area below the letters “an”, the alphabet region would include a family of words which rhyme with “man” (such as “fan”, “can”, “ran”, etc.) and/or which include the “an” sound (e.g., “hand”, “stand”, etc.) In another example, a box in the alphabet region may include the letters “ap” along with the word “map” and a picture of a map, followed by a family of words which rhyme with “map” (such as “lap”, “nap”, “cap”, etc.) and/or which include the “ap” sound (such as “happy”, “apple”, etc.).

In a further variant of the present invention, the educational devices may be based upon a particular theme. For example, the pictures and words in the alphabet region may all relate to a particular subject, such as astronomy, geography, history, mathematics, etc., and the information in the teaching areas may relate to the same subject.

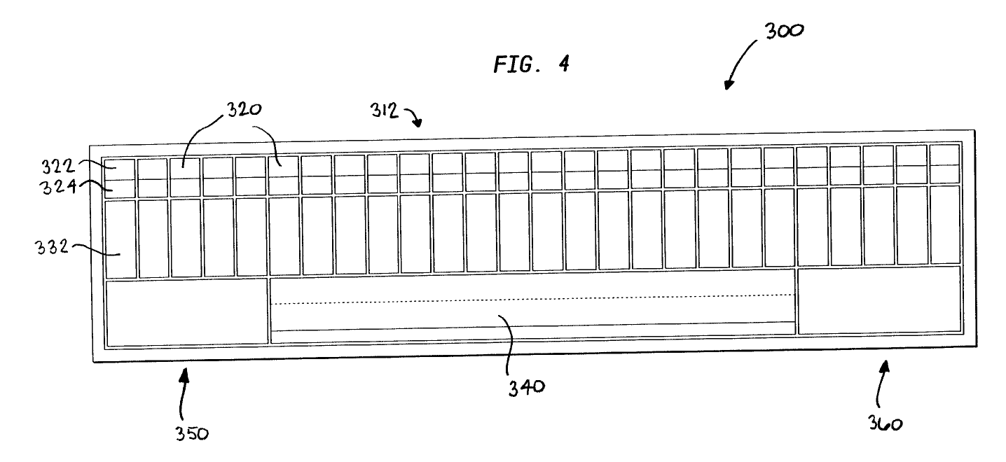

FIG. 4 illustrates a template 300 for forming educational devices in accordance with the preferred embodiments depicted in FIGS. 1, 2 and 3. As shown in the figure, these embodiments generally include an alphabet region 312 having a series of boxes 320, one for each letter or letter combination depicted on the chart. Each box 320 includes a top portion 322 including the letter or letter combination along with a word beginning with that letter, and a bottom portion 324 in which a picture of an object denoted by the word is depicted. Below each box 320 is an elongated box 332 which includes a list of words related in some way to the letter or combination of letters under which it is positioned. Centrally disposed below boxes 332 is a substantially blank area 340 which can be used to write the child's name, to practice lettering, to practice spelling, or for other similar writing uses. On either side of substantially blank area 340 are regions 350 and 360 in each of which information may be supplied for teaching one or more subjects. Finally, a space is provided below substantially blank area 340 and regions 350 and 360 in which a number array may be provided.

It should be noted that the positions of the various regions of the educational device are not particularly critical. For example, while it is preferred that boxes 20 are arranged along a top portion of chart 10 (as well as the other charts described herein), that need not be the case, and boxes 20 may be arranged along a bottom portion of chart 10. Alternatively, while less desirable, chart 10 may be oriented in a vertical direction, with boxes 20 arranged along the left or right side thereof. Similarly, while each of the embodiments have been described above as including a substantially blank portion in a lower central region with first and second teaching regions on either side thereof, the present invention is not limited to such arrangement. Thus, the present invention may include a substantially blank region with no teaching regions on one side thereof and one or multiple teaching regions on the other side thereof; or a plurality of teaching regions arranged alongside one another with no substantially blank region at all. Further, rather than a teaching region, the chart of the present invention may include a blank space in which a child could draw or attach a picture of themself.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as set forth in the appended claims.

1. An educational chart, comprising:
a substrate;
a plurality of letter regions formed on said substrate for use in teaching a user reading concepts, each of said letter regions including a letter of an alphabet or a combination of letters of said alphabet, and a series of words corresponding to said letter or said combination of letters; and
at least one teaching region including information for use in teaching said user a first subject.

2. The educational chart as claimed in claim 1, wherein said first subject is different from said reading concepts.

3. The educational chart as claimed in claim 1, wherein each of said letter regions further includes a picture of an object corresponding to said letter or said combination of letters.

4. The educational chart as claimed in claim 3, wherein each of said 1

5. The educational chart as claimed in claim 3, further comprising a background color surrounding each of said pictures of said objects, wherein said background color for each of said pictures is different from a background color for an adjacent one of said pictures.

6. The educational chart as claimed in claim 1, further comprising another teaching region including information for use in teaching said user a second subject different from said reading concepts.

7. The educational chart as claimed in claim 6, wherein said first subject is different from said reading concepts.

8. The educational chart as claimed in claim 6, wherein said second subject is different from said first subject.

9. The educational chart as claimed in claim 1, wherein said first subject is selected from the group consisting of number concepts, color concepts, directional concepts, geometric concepts, writing concepts, time concepts, calendar concepts, astronomy concepts, language concepts, mathematics concepts, measurement concepts, chemistry concepts, historical concepts, geographical concepts, reading concepts and combinations thereof.

10. The educational chart as claimed in claim 1, wherein said first subject is selected from the group consisting of contractions, abbreviations and combinations thereof.

11. The educational chart as claimed in claim 1, further comprising a series of numbers arranged in a linear array.

12. The educational chart as claimed in claim 1, further comprising a ruler.

13. The educational chart as claimed in claim 1, further comprising a substantially blank area positioned adjacent said plurality of letter regions.

14. The educational chart as claimed in claim 13, wherein said substantially blank area has an erasable surface.

15. The educational chart as claimed in claim 13, further comprising another teaching region including information for use in teaching said user a second subject different from said reading concepts and different from said first subject.

16. The educational chart as claimed in claim 1, wherein said alphabet is an Arabic alphabet.

17. The educational chart as claimed in claim 1, wherein said alphabet is a foreign language alphabet.

18. The educational chart as claimed in claim 1, wherein said substrate has a pair of opposed longitudinal edges, said plurality of letter regions being formed along one of said longitudinal edges.

19. The educational chart as claimed in claim 18, further comprising a series of numbers arranged in a linear array along another one of said longitudinal edges.

20. The educational chart as claimed in claim 18, comprising a ruler formed along another one of said longitudinal edges.

21. The educational chart as claimed in claim 1, wherein each of said words in said series begins with said letter or said combination of letters.

22. The educational chart as claimed in claim 1, wherein each of said letter regions includes said combination of letters, and each of said words in said series includes said combination of letters.

23. The educational chart as claimed in claim 22, wherein said combination of letters represents a sound, and each of said words in said series rhymes with said sound.

24. An educational chart, comprising:
a substrate;
an alphabet region formed on said substrate for use in teaching a user reading concepts, said alphabet region including letters of an alphabet, for each of said letters of said alphabet said alphabet region including a series of words corresponding to said letter; and
at least one teaching region including information for use in teaching said user a first subject.

25. The educational chart as claimed in claim 24, wherein said first subject is different from said reading concepts.

26. The educational chart as claimed in claim 24, wherein, for each of said letters of said alphabet, said alphabet region further includes a picture of an object corresponding to said letter of said alphabet.

27. The educational chart as claimed in claim 26, wherein, for each of said letters of said alphabet, said alphabet region further includes a word identifying said object.

28. The educational chart as claimed in claim 24, wherein each word in said series of words begins with said letter.

29. The educational chart as claimed in claim 24, wherein said alphabet is an Arabic alphabet.

30. The educational chart as claimed in claim 24, wherein said alphabet is a foreign language alphabet.

31. The educational chart as claimed in claim 24, wherein said letters are vowels or combinations of vowels.

32. The educational chart as claimed in claim 24, further comprising another teaching region including information for use in teaching said user a second subject different from said reading concepts.

33. The educational chart as claimed in claim 32, wherein said second subject is different from said first subject.

34. The educational chart as claimed in claim 24, further comprising a series of numbers arranged in a linear array.

35. The educational chart as claimed in claim 24, further comprising a ruler.
